(19) United States
(12) Patent Application Publication
(10) Pub. No.: US 2008/0282860 A1
(43) Pub. Date: Nov. 20, 2008

(54) Apparatus for Scrap Removal From Rotary Cutting Tool

(76) Inventor: Alan R. Pfaff, JR., Orchard Lake, MI (US)

Correspondence Address: Robert K. Roth;Miller, Canfield, Paddock and Stone, P.L.C., 150 W. Jefferson, Suite 2500, Detroit, MI, 48226, US

(21) Appl. No.: 12/091,822

(22) PCT Filed: Oct. 27, 2006
(86) PCT No.: PCT/US2006/042259

§ 371 Date: Apr. 28, 2008

Related U.S. Application Data
(60) Provisional application No. 60/730,902, filed on Oct. 27, 2005.

(51) Int. Cl. B26D 7/06

(52) U.S. Cl. 83/128

(57) ABSTRACT

A rotary cutting tool for cutting a moving web of material into blanks and scrap material, comprises an upper cutting assembly having an upper cutting element which defines a cutout area on the upper cutting assembly, a lower cutting assembly having a lower cutting element, wherein the upper cutting element and the lower cutting element are adapted to cooperate to cut the moving web of material into blanks and scrap material, and a scrap ejection element on the upper cutting assembly at the cutout area which can urge the scrap material away from the blanks and towards the lower cutting elements, wherein the scrap ejection element is formed unitary with the upper cutting element.

### RELATED APPLICATION

This application claims priority benefit of U.S. provisional patent application No. 60/730,902 filed on Oct. 27, 2005.

### FIELD OF THE INVENTION

This invention relates to improvements in rotary cutting tools, and more particularly to improvements in scrap removal from rotary cutting tools.

### BACKGROUND OF THE INVENTION

Rotary cutting tools are useful for manufacture of carton blanks and other workpieces from sheets or webs of material. In particular, rotary die cutting tools are used in high speed cutting of a moving sheet or web of paper, paperboard, plastics or composite materials. As one example, rotary die cutting machines are used for the high speed mass production of paperboard carton blanks that are subsequently folded into the shape of cartons or boxes such as cereal and cracker boxes, etc. The cutting operations can occur by one of several methods: rotary pressure (“RP”) cutting and the “crush cut” method. In the rotary pressure cutting method, a web of material is advanced at high speed between two rotary die cutting cylinders. The cylinders are provided with cutting elements which cooperate to cut the desired shape of the carton blank out of the web as the material advances between the cylinders. The cutting elements are offset but immediately adjacent one another when cutting the web of material (somewhat like a pair of scissors), so that a cut line is defined at edges where the cooperating cutting elements meet. The cylinders rotate at the same speed so as to maintain registration of the co-acting cutting surfaces. Each rotation of the cylinders generates a discrete series of one or more cartons depending upon the size of the cartons, diameters of the cylinders, etc.

By contrast, in the crush cut method one of the cylinders, a cutting cylinder, is provided with knife blades that perform the cutting operation and the other cylinder, known as the anvil cylinder, provides a smooth surface against which the knife blades operate. The knife blades are therefore positioned directly over the anvil, instead of being offset as is the case with RP dies.

Once the carton is cut, material is sometimes left behind, for example edges and cutouts. Given the high speed operation typical of rotary cutting, this scrap material needs to be separated from the usable product in a simple, quick and reliable manner. Known techniques for scrap removal include placing a rubber spacer on a cutout area of one of the cylinders corresponding to the cutout from the web of material, and drilling and tapping holes into a second cylinder and inserting stripping pins. During the cutting action, the rubber biases the scrap material away from the first cylinder and toward the stripping pin on the other cylinder. The stripping pin temporarily captures the scrap and carries it away from the carton blanks defined by the cutting action. The stripping pins engage stripping combs mounted at a fixed position. Typically the combs have thin slots which receive the stripping pins, but which are not large enough to allow the scrap to pass. Rotation of the cylinder allows the pins to pass through the comb, but not the scrap, and so the scrap is pulled off the pin. In this manner the scrap is separated from the carton blanks.

There are several problems with this known technique for scrap removal. The technique is relatively expensive, as stripping pins and stripping comb have to be precisely manufactured and mounted. Also, small misalignments can result in the stripping comb shearing off the stripping pins. Further, over time the rubber spacers can become compressed, losing their effectiveness. In addition, there is increased demand for small volume production runs, and as each run may have a different scrap or cutout location, the mounting holes that work for one production run may not work for another production run, effectively dedicating the cylinders to a limited production of carton blanks.

It would be highly desirable to provide a rotary tool having an improved scrap removal apparatus which is of lower cost and is easier to manufacture and assemble, and to provide a scrap removal apparatus for a rotary cutting tool which is amendable to multiple lower volume production runs.

### SUMMARY OF THE INVENTION

In accordance with a first aspect, a rotary cutting tool for cutting a moving web of material into blanks and scrap material, comprises an upper cutting assembly having an upper cutting element which defines a cutout area on the upper cutting assembly, a lower cutting assembly having a lower cutting element, wherein the upper cutting element and the lower cutting element are adapted to cooperate to cut the moving web of material into blanks and scrap material, and a scrap ejection element on the upper cutting assembly at the cutout area which can urge the scrap material away from the blanks and towards the lower cutting elements, wherein the scrap ejection element is formed unitary with the upper cutting element.

From the foregoing disclosure and the following more detailed description of various preferred embodiments it will be apparent to those skilled in the art that the present invention provides a significant advance in the technology of rotary cutting tools. Particularly significant in this regard is the potential the invention affords for providing a high quality, low cost rotary cutting tool. Additional features and advantages of various preferred embodiments will be better understood in view of the detailed description provided below.

### BRIEF DESCRIPTION OF THE DRAWINGS

FIG. 1 is a perspective view of a rotary cutting tool having an upper cylinder and a lower cylinder in accordance with a preferred embodiment.

FIG. 2 is schematic view of a pair of cooperating rotary pressure die plates with scrap ejection elements.

FIG. 3 is a schematic side view of a web of material being cut with rotary pressure dies and producing a blank and scrap material.

FIG. 4 shows the scrap material temporarily captivated by lower cutting elements.

FIG. 5 shows the lower cutting assembly rotated to a position just before the stripping blade assembly engages and separates the scrap material from the lower cutting assembly.

FIG. 6 is a side view of another preferred embodiment of a rotary cutting tool showing cooperating crush cut cutting surfaces cooperating to cut a material, with scrap ejection elements urging a piece of scrap away from an upper cylinder.

FIG. 7 a cross section view of a rotary cutting tool, shown near a point where the material is cut and scrap is produced.

FIG. 8 shows continued rotation of the cylinders from FIG. 7, with the scrap material engaging the lower cylinder.

FIG. 9 shows continued rotation of the cylinders from FIG. 8, with the scrap material engaging a stripper blade to separate the scrap material from the lower cylinder.

It should be understood that the appended drawings are not necessarily to scale, presenting a somewhat simplified representation of various preferred features illustrative of the basic principles of the invention. The specific design features of the rotary cutting tool as disclosed here, including, for example, the specific dimensions of the scrap ejection elements, will be determined in part by the particular intended application and use environment. Certain features of the illustrated embodiments have been enlarged or distorted relative to others to improve visualization and clear understanding. In particular, thin features may be thickened, for example, for clarity of illustration. All references to direction and position, unless otherwise indicated, refer to the orientation illustrated in the drawings.

### DETAILED DESCRIPTION OF CERTAIN PREFERRED EMBODIMENTS

It will be apparent to those skilled in the art, that is, to those who have knowledge or experience in this area of technology, that many uses and design variations are possible for the rotary cutting tool disclosed here. The following detailed discussion of various alternative and preferred features and embodiments will illustrate the general principles of the invention with reference to a rotary cutting tool suitable for use in industrial applications where flat paper-like materials are to be cut. Other embodiments suitable for other applications will be apparent to those skilled in the art given the benefit of this disclosure.

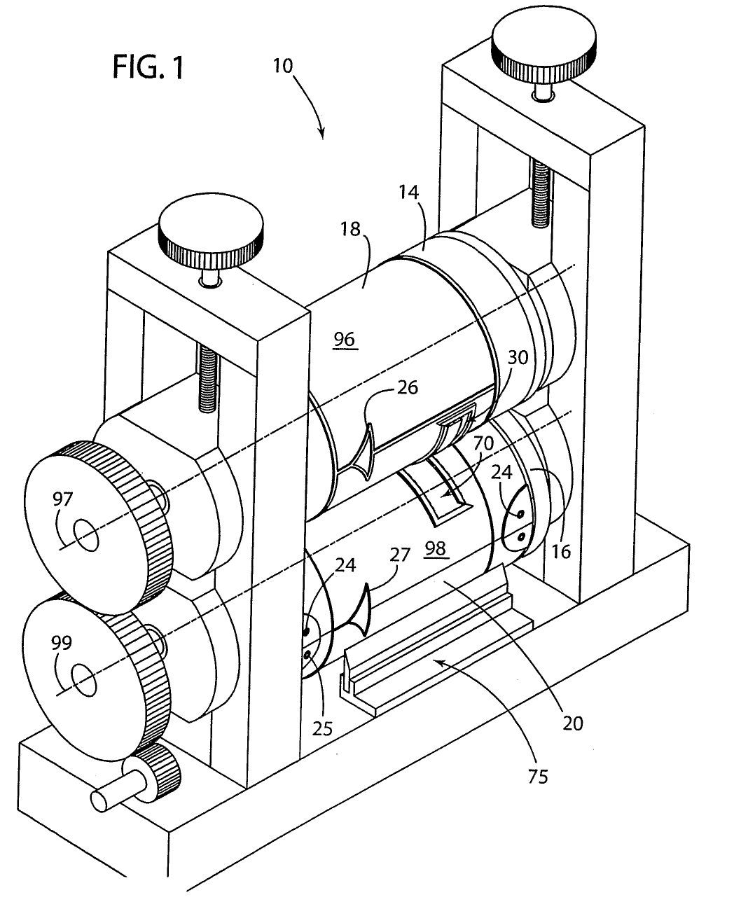

Referring now to the drawings, in FIG. 1 shows a rotary cutting tool 10 in accordance with a preferred embodiment having an upper die cutting assembly 96 and a lower die cutting assembly 98. The upper die cutting assembly has a cylinder 14 and die plate 18 wrapped around the cylinder, and the lower die cutting assembly 98 has a cylinder 16 and a die plate 20 wrapped around the cylinder. Each of the assemblies 96, 98 are mounted on a stand 12 so that the cylinders 14, 16 come into close proximity with one another. The upper cylinder 96 is rotatable about axis 97 and the lower cylinder is rotatable about axis 99, with the axes 97 and 99 generally parallel with one another. Each die plate's position is preferably adjustable with respect to the die cylinder at one or more mounting locations 24, 25.

Each die plate has cutting blades or elements 26, 27, preferably formed as unitary extensions of the corresponding die plate. The cylinders 14, 16 are in registry with one another so that they rotate together. When a thin web of material (for example, paperboard used to make cereal boxes) is fed between the rotating die plates 18, 20, the cutting elements or blades 26, 27 cut the thin web of material into carton blanks. Sometimes a carton design calls for a cutout. This cutout is a scrap material which must be separated from the blank.

The cutting elements 26, 27 on each die plate (or cylinder) define a cutout area 30, 70. The cutout area on each die plate corresponds to an area of the web of material which is cut and converted to scrap material. This can take on many shapes, but generally either the cutting elements entirely surround the cutout area or an edge of the web of material cooperates with the cutting elements to define the cutout area. In either situation, when the upper cutting assembly 96 cooperates with the lower cutting assembly 98, scrap is produced at the portion of the web of material corresponding to the cutout area.

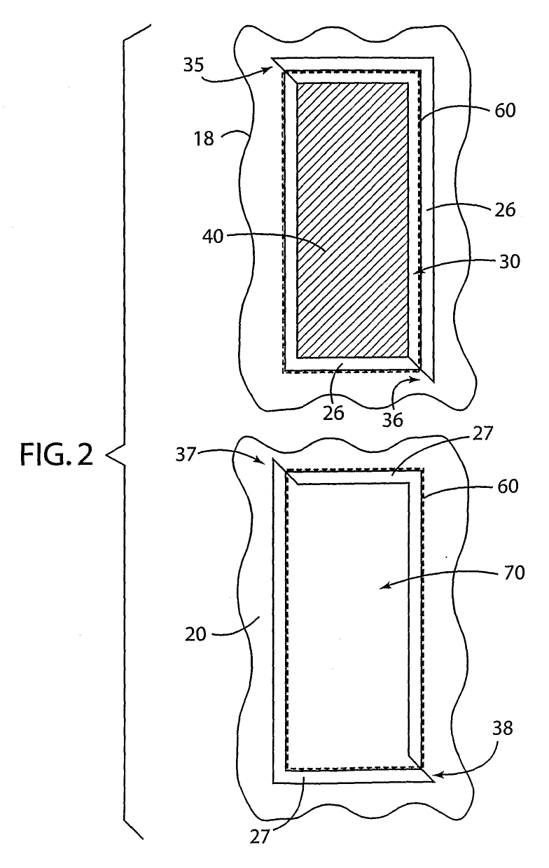

FIGS. 1-2 show an example where the cutout scrap is generally arcuate cylindrical section, shown simplified in FIG. 2 as being generally rectangular in shape. In FIG. 2, a schematic view of the cutout areas 30, 70 of the upper and lower die plates, 18, 20 respectively, is shown. This drawing shows a rotary pressure design where the cutting elements 26 and 27 are offset from one another. A cut line 60 of the web of material is shown as a dashed line immediately adjacent the cutting elements 26 and 27. FIG. 2 also shows crossovers 35, 36 on the upper die plate 18 and lower crossovers 37, 38 on the lower die plate. These crossovers take advantage of the flexibility of the web of material to allow for simplified position adjustment as the parts wear.

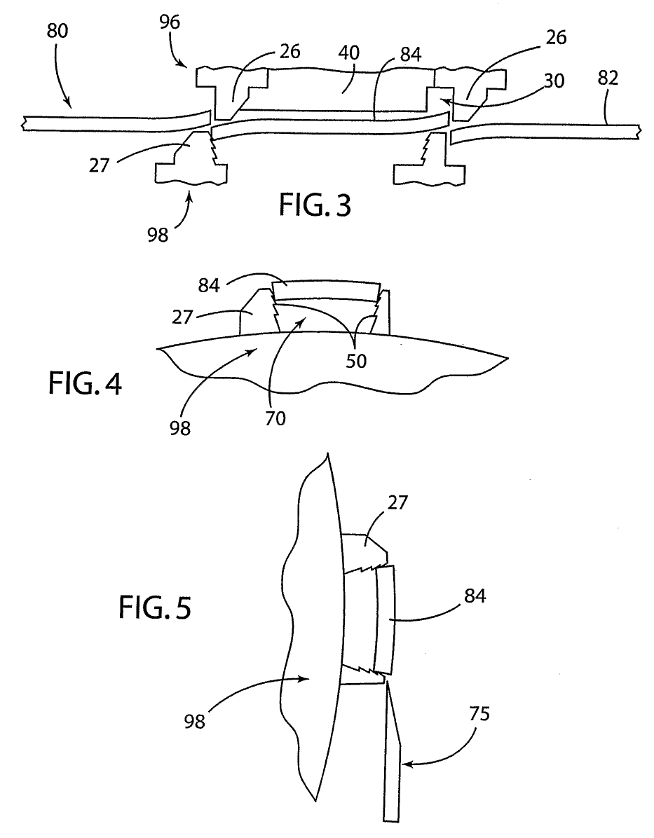

A scrap ejection element 40 in accordance with a preferred embodiment is shown as a unitary extension of die plate 18. Preferably the scrap ejection element has a radial length about the same as a radial length of the die cutting elements 26. A gap in the cutout area 30 is provided to allow room for the lower cutting elements 27 when the cutting assemblies come together to cut the web of material. FIG. 3 shows that as the web of material 80 is cut into blanks 82, the scrap material 84 is formed. Scrap ejection element 40 is shown in FIGS. 1-3 taking up most of the cutout area 30, but can include significantly less than all of the cutout area 30. The scrap ejection element urges the scrap material 84 away from the upper cutting assembly (and upper cutting elements 26) and toward the lower cutting assembly (and lower cutting elements 27). The scrap ejection element does not cut the web of material, but is preferably formed as a unitary extension of the same part which has a unitary extension forming the cutting elements. For example, a die plate 18 may advantageously be machined to include both cutting elements and a scrap ejection element.

The scrap ejection element 40 cooperates with the lower cutting elements 27 to separate the scrap material from the carton blanks 82. Cutout area 70 on the lower die plate 20 is adapted to receive the scrap material. FIG. 4 shows the scrap material temporarily captivated on the lower cutting assembly by the lower cutting elements 27. In accordance with a highly advantageous feature, the lower cutting elements 27 may be provided with retaining barbs 50 (again preferably formed as unitary extensions of the cutting elements and the die plate 20) which help temporarily captivate the scrap material.

Continued rotation of the lower cutting assembly 98 away from the position where the cutting elements 26 and 27 meet to form the scrap material brings the scrap material 84 into contact with the stripper assembly 75 which is fixed to the stand 12. The stripper blade assembly engages the scrap material 84, but not the cutting elements 27. This separates the scrap material from the lower cutting elements 27, allowing the cutting elements to rotate back around to reengage the upper cutting elements 26 and repeat the process. Advantageously, the stripper blade assembly may be much simpler to construct than known scrap removal blades, as a tightly toleranced slot to engage stripper pins is not necessary with this invention.

Summarizing the process of scrap removal from the web of material, as a first step, the material is cut into carton blanks 82 and scrap material 84. Next and essentially concurrently, the scrap ejection elements urge the scrap material away from the blanks and into engagement with the lower cutting elements. Rotation of the lower cutting assembly separates the scrap material from the blanks and brings the scrap material into engagement with the stripper blade assembly. The stripper blade assembly separates the scrap material from the lower cutting assembly.

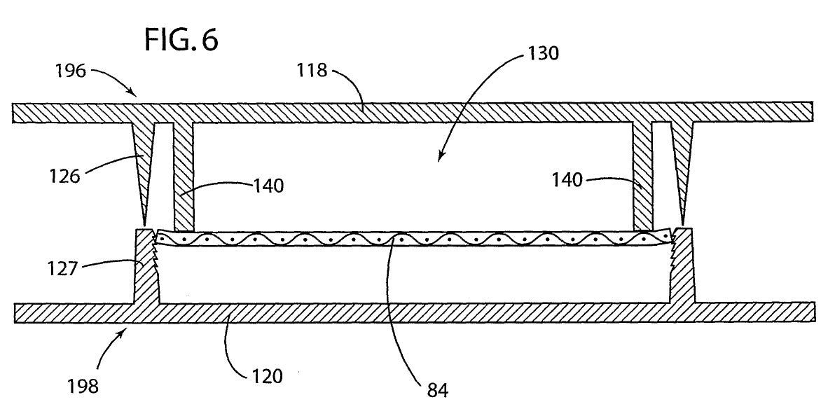

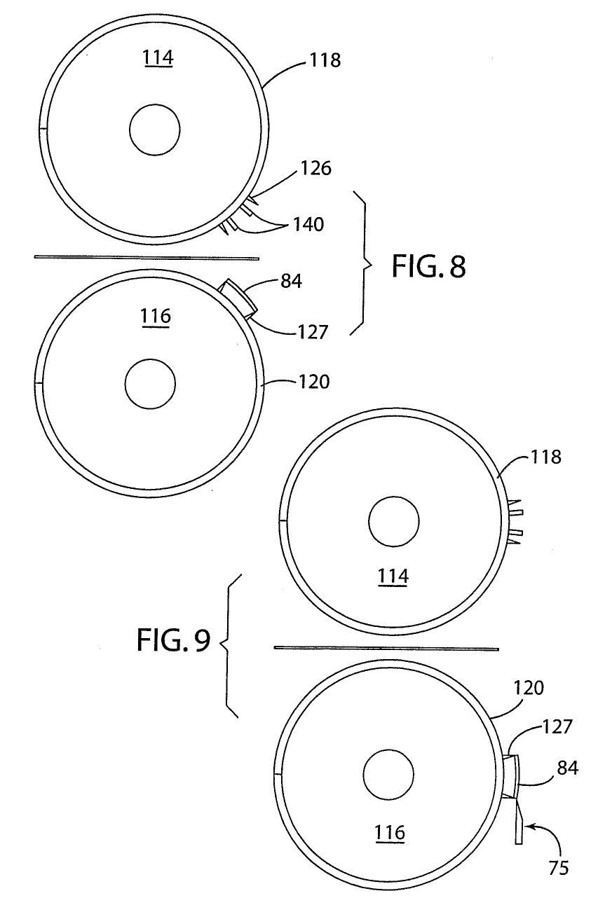

FIGS. 6-9 show a series of simplified schematic views of a crush cut rotary cutting tool with a scrap removal element 140 in accordance with another preferred embodiment. With crush cut rotary dies, one of the rotary cutting assemblies 196 is formed with upper cutting elements 126 and the other rotary cutting assembly 198 is formed with lower cutting elements or anvil elements 127. The die plate 118 having the cutting elements may also be provided with a scrap ejection element 140. As with RP dies, the scrap ejection element is positioned in the cutout area 130 and can take on a variety of shapes, has a radial length about the same as a radial length of the upper cutting element and does not cut the web of material.

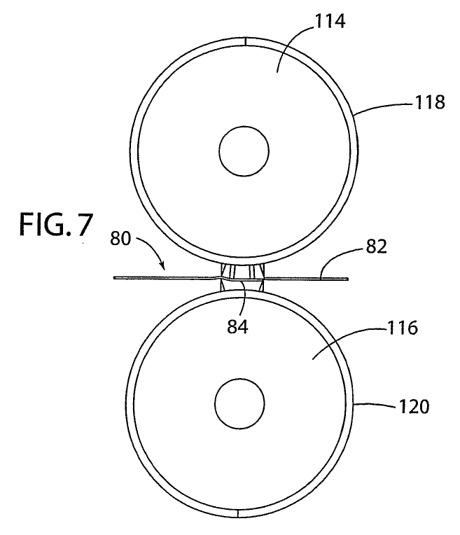

The process for scrap material removal is essentially the same as with RP dies. FIGS. 7-9 show the steps of separating the scrap material 84 from the blanks 82. First, the blank 82 and scrap material 84 are cut from the web of material 80 by rotation of cylinders 114 and 116. As the scrap material 84 is formed it is compressed toward the anvil element 127 by the scrap ejection element 140. An upper vertical surface of the anvil element is preferably machined with one or more ridges which are preferably sharp at their ends. Theses ridges or barbs serve to help temporarily captivate or retain the scrap piece to the die plate. Next, continued rotation of the cylinders separates the scrap material from the blanks. This continues until the cylinder 116 (and corresponding die plate 120) rotates to engage a stripper blade assembly 75. The stripper blade assembly catches an edge of the scrap portion 84, and a conventional vacuum material handling system (not shown) can collect the scrap portions, efficiently removing them from the operation.

Optionally, the upper cutting assembly can comprise either both a cylinder and separate die plate with cutting elements and scrap ejection elements formed as unitary extensions of the die plate (a “flexible die” as shown in the Figs.) or just a solid cylinder with unitary projections extending from the cylinder to form cutting elements and the scrap ejection element (a “solid die”). In a similar manner, the lower cutting assembly can comprise either both a cylinder and separate die plate with cutting elements formed as unitary extensions of the die plate (a “flexible die” as shown in the Figs.) or just a solid cylinder with unitary projections extending from the cylinder to form cutting elements (“a solid die”).

From the foregoing disclosure and detailed description of certain preferred embodiments, it will be apparent that various modifications, additions and other alternative embodiments are possible without departing from the true scope and spirit of the invention. The embodiments discussed were chosen and described to provide the best illustration of the principles of the invention and its practical application to thereby enable one of ordinary skill in the art to use the invention in various embodiments and with various modifications as are suited to the particular use contemplated. All such modifications and variations are within the scope of the invention as determined by the appended claims when interpreted in accordance with the breadth to which they are fairly, legally, and equitably entitled.

What is claimed is:

1. A rotary cutting tool for cutting a moving web of material into blanks and scrap material, comprising, in combination:
an upper cutting assembly having upper cutting elements which define a cutout area on the upper cutting assembly;
a lower cutting assembly having lower cutting elements, wherein the upper cutting elements and the lower cutting elements are adapted to cooperate to cut the moving web of material into blanks and scrap material; and
a scrap ejection element on the upper cutting assembly at the cutout area adapted to urge the scrap material away from the blanks and towards the lower cutting elements, wherein the scrap ejection element is formed unitary with the upper cutting element.

2. The rotary cutting tool of claim 1 wherein the upper cutting assembly comprises an upper cylinder and a die plate wrapped around the cylinder, and the upper cutting elements and the scrap ejection element are formed as unitary extensions of the upper die plate.

3. The rotary cutting tool of claim 1 wherein the lower cutting assembly comprises a lower cylinder and a die plate wrapped around the lower cylinder, and the lower cutting elements is formed as a unitary extension of the lower die plate.

4. The rotary cutting tool of claim 1 wherein the upper cutting assembly comprises an upper cylinder, the lower cutting assembly comprises a lower cylinder, the upper cutting elements and scrap ejection element are formed as unitary extensions of the upper cylinder, and the lower cutting elements are formed as a unitary extension of the lower cylinder.

5. The rotary cutting tool of claim 1 wherein the lower cutting elements have a retaining barb which temporarily captivates the scrap material.

6. The rotary cutting tool of claim 1 further comprising a stand which mounts the upper cutting assembly and the lower cutting assembly so that both are rotatable around generally parallel axes, and the cutting assemblies are adapted to receive the web of material between the cutting assemblies and cut the web of material into blanks and scrap material.

7. The rotary cutting tool of claim 6 further comprising a stripping blade mounted on the stand and having a blade edge which is adapted to strip away the scrap material from the lower cutting assembly.

8. The rotary cutting tool of claim 6 wherein the cutting elements which define the cutout area cooperate with lower cutting elements around a lower cutout area to cut the scrap material from the web of material.

9. The rotary cutting tool of claim 1 wherein the scrap ejection element has a radial length about the same as a radial length of the upper cutting elements.

10. The rotary cutting tool of claim 1 wherein the scrap ejection element does not cut the web of material.
